(19) United States
(12) Patent Application Publication
(10) Pub. No.: US 2024/0181626 A1
(43) Pub. Date: Jun. 6, 2024

(54) ROBOTIC INSPECTION SYSTEMS AND METHODS

(71) Applicant: Michael D. SLAWINSKI, Placerville, CA (US)

(72) Inventor: Michael D. SLAWINSKI, Placerville, CA (US)

(21) Appl. No.: 18/438,186

(22) Filed: Feb. 9, 2024

Related U.S. Application Data
(63) Continuation-in-part of application No. 18/382,448, filed on Oct. 20, 2023.
(60) Provisional application No. 63/418,378, filed on Oct. 21, 2022.

(51) Int. Cl. B25J 5/00; B25J 9/08; B25J 19/02; B25J 19/06

(52) U.S. Cl. CPC B25J 5/007; B25J 19/023; B25J 9/08; B25J 19/026; B25J 19/06

(57) ABSTRACT

An inspection robot includes wheels or treads attached to sides of a chassis and extending below the chassis. One or more rollers may be in the chassis may extend from the underside of the chassis but do not extend to a plane defined by the bottoms of the wheels or treads. A drive system can rotate the wheels or treads and the rollers. In particular, rotation of the rollers may move the robot when the chassis bottoms out, for example, when the robot traverses the peak of a roof or traverses any projection in terrain that the robot may need to navigate.

### REFERENCE TO RELATED APPLICATIONS

This patent document is a continuation-in-part and claims benefit of the earlier filing date of U.S. patent application Ser. No. 18/382,448, filed Oct. 20, 2023, which claims benefit of U.S. Provisional Pat. App. No. 63/418,378, filed Oct. 21, 2022, both of which are hereby incorporated by reference in their entirety.

### BACKGROUND

Direct inspection of buildings or other structures can be inconvenient or dangerous. For example, climbing onto and inspecting a roof, on foot, are inherently dangerous, and every year, people are injured or killed in falls from ladders or roofs. Crawlspace inspections, for example, under buildings or in attics, drains, or ductwork, can be inconvenient to access even when large enough for an inspector or may be impossible for an inspector to access when the crawlspaces are too small for the inspector to enter.

Robotic inspection systems have been developed in which a remotely controlled robot having an imaging system can be deployed at an accessible area of a roof, crawlspace, or other area to be inspected, and the robotic inspection systems can navigate around the roof, crawlspace, or other area capturing images of objects being inspected. Such robots face challenges. For example, a roof inspecting robot may need to climb steep roof pitches, navigate around a roof without falling off an edge of the roof, traverse peaks and valleys of the roof without getting stuck, and position a camera to provide views that an inspector may need to evaluate the roof. Similarly, in crawlspaces, an inspection robot may need to travers a rough or inclined surfaces, navigate around or over structures such as pipes, avoid getting stuck or flipping over, and position the imaging system to provide views that an inspector may need.

Some example robotic inspection systems and methods and components thereof are described in U.S. Pat. No. 8,621,206 entitled “Roof Inspection Systems and Methods of Use,” U.S. Pat. No. 8,789,631 entitled “Roof Inspection Systems with Autonomous Guidance,” U.S. Pat. No. 9,010,465 entitled “Robotic Vehicle Systems for Inspecting Remote Locations,” and U.S. Pat. No. 9,283,681 entitled “Robotic Vehicle Systems for Inspecting Remote Locations,” all of which are hereby incorporated by reference in their entirety.

Current robotic inspection systems and methods need reliability and performance improvements.

### BRIEF DESCRIPTION OF THE DRAWINGS

FIGS. 1A and 1B respectively show a block diagram and a schematic side view of an inspection robot having wheels in accordance with an example of the present disclosure.

FIG. 1C shows the robot using an under-chassis roller to propel the robot over a peak of a peaked surface.

FIG. 1D shows the robot when equipped with wheels having magnetic cleats.

FIGS. 2A and 2B respectively show a block diagram and a schematic side view of the inspection robot of FIGS. 1A and 1B in a configuration in which the wheels have been replaced with treads.

FIG. 3 is a schematic illustration of a remote console including a tablet computer and a controller according to an example of the present disclosure.

FIG. 4A illustrates an example of an inspection robot with a telescoping camera mounting structure in accordance with an example of the present disclosure when encountering an object to be inspected.

FIG. 4B illustrates the inspection robot with the telescoping camera mounting structure extended for inspection of a top surface of the encountered object.

FIG. 5 illustrates a pole system in accordance with an example of the present disclosure for lifting or lowering an inspection robot to or from a raised elevation such as a roof.

The drawings illustrate examples for the purpose of explanation and are not of the invention itself. Use of the same reference symbols in different figures indicates similar or identical items.

### DETAILED DESCRIPTION

Robotic systems and methods as disclosed herein provide flexibility to quickly change from using wheels or treads/belts as needed to navigate an inspection area, e.g., a roof, crawlspace, or other area containing surfaces or objects to be inspected. An inspection robot in accordance with one example of the present disclosure may be operable with interchangeable wheels or treads and a quick-change system the allows quickly changing the inspection robot from use of wheels to use of treads for locomotion. The quick-change system may include movable posts that act as idlers on the left and right sides of the inspection robot. In a wheeled configuration of the inspection robot, each side has a powered wheel and a free-wheeling wheel, and a drive belt connects the powered wheel to the free-wheeling wheel, and an idler post maintains tension in the drive belt. In a treaded configuration, a tread wraps around a powered gear and a free-wheeling gear, and the idler post maintains tension in the tread and provides a raise portion of the tread that allows the inspection robot to maintain a low center of gravity when crossing a roof peak or other raised feature.

In some other examples, wheels or treads of an inspection robot may be equipped with removable cleats made of foam, a magnetic material, or other material that improves traction on a target surface and that is removable and replaceable when the cleats become worn or when cleats adapted for a different surface are needed. In one specific case, magnetic cleats, which may or may not be removeable and replaceable, on treads or wheels may allow an inspection robot to reliably climb steep ferromagnetic surfaces such as galvanized iron roofing. An inspection robot in one example of the present disclosure may include powered underside rollers or that extend from an underside of the chassis of robot at locations, e.g., a midpoint of the underbelly of the robot, that might bottom out, e.g., contact projections from rough ground, a peak of a roof, or the top of a horizontal pipe. As a result, when the underbelly of the robot contacts an obstruction that might otherwise strand the robots, the rollers contact the obstruction and can propel the inspection robot over the obstruction.

In accordance with another aspect of the current disclosure, autonomous navigation and locomotion features of an inspection robot allow the robot to navigate an inspection area more reliably. An inspection robot in accordance with one example includes an accelerometer or other tilt sensor, and an autonomous control system of the robot may detect when a tilt/orientation of the robot approaches a tipping point that could flip the inspection robot over or into an inoperable or unsafe orientation. The autonomous control system may prevent a remote operator of the inspection robot from unintentionally flipping or otherwise stranding the robot at a difficult to access location. An inspection robot may further include a forward-facing sonar system or other obstruction detector that identify obstructions that may not be visible to the operator of the robot so that the inspection robot may alert its operator or autonomously avoid the obstruction.

In accordance with yet another aspect of the current disclosure, an inspection robot may employ an actuated mounting structure that can extend and orient a camera or other imaging system on the inspection robot to view over an obstruction or to view the top of an object and can lower and reorient the camera or imaging system to lower the center of gravity of the inspection robot for navigation when such viewing is not required. One specific application, for example for termite inspection, allows the inspection robot to navigate to a vertical obstacle such as a raised foundation, drive partially up the raised foundation to a maximum safe tilt of the inspection robot, and then extend and orient the camera to view a mudsill on top of the raised foundation.

In accordance with yet another aspect of the current disclosure, a robot deployment and removal system includes a base, an extendible pole that fits into the base, and a basket that is at a top end of the extendible pole and that holds an inspection robot. For a roof inspection, the inspection robot may be placed in the basket on top of the extendible pole and the extendible pole may be anchored in the base. The pole may then be extended until the basket reaches edge of the roof where the basket may release the inspection robot and the inspection robot may be driven from the basket onto the roof. The inspection robot may thus be deployed without the need of a ladder that an operator needs to claim or a lift that would raise the operator of the inspection robot to deploy the robot on the roof to be inspected. Similarly, when the inspection needs to be removed from a roof or other raised area, the inspection robot may be navigated from the roof or raised area into the basket, and the basket with the inspection robot may be lower. The basket may be shaped to include a full or partial top that prevents the robot from falling out of the top of the basket, and the basket may be weighted to tilt the robot back away from an opening through which the inspection robot can be placed in or leave the basket.

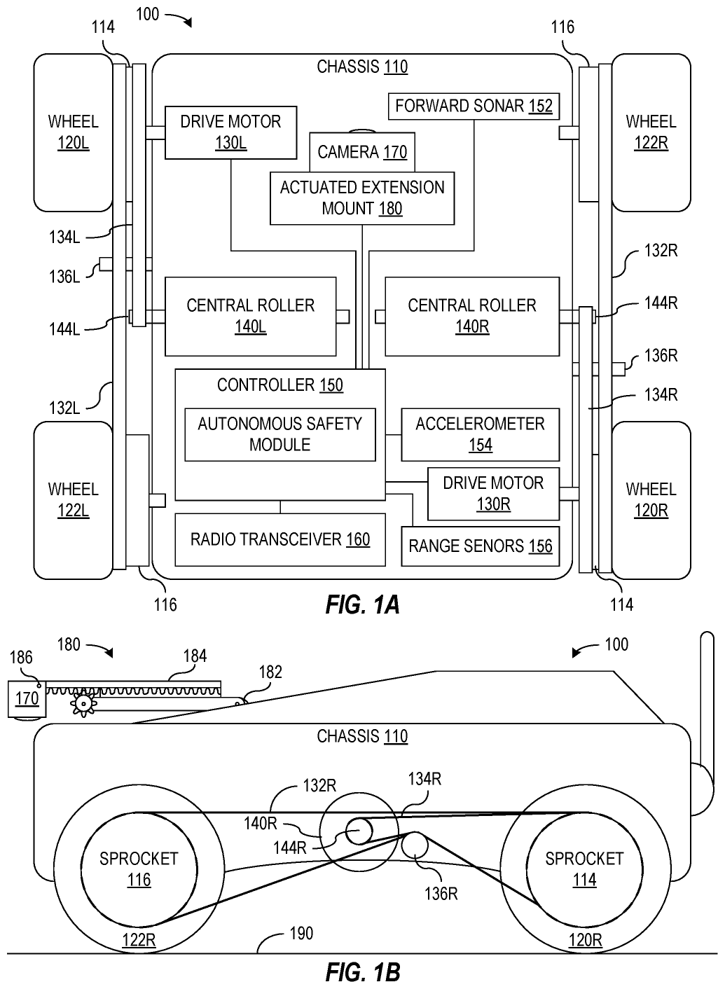

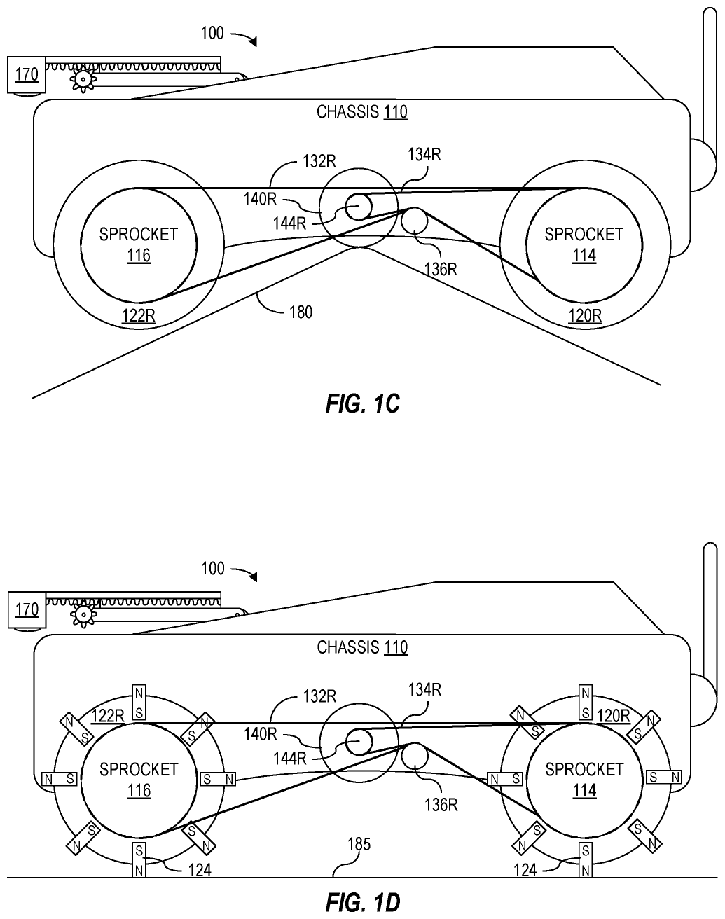

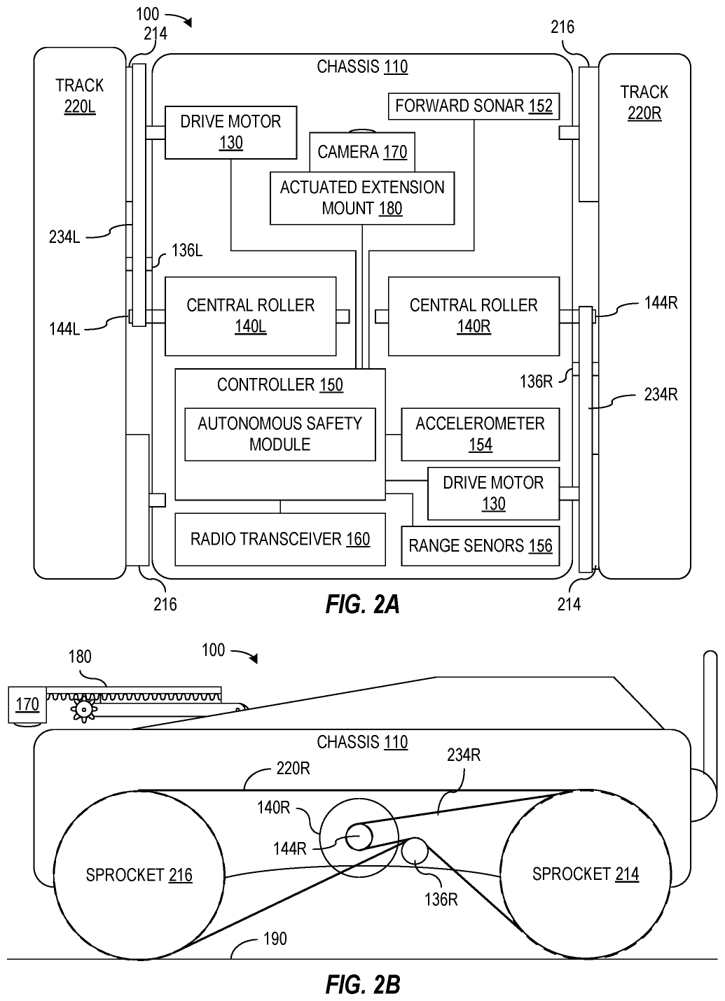

FIGS. 1A and 1B respectively show a block diagram and a schematic side view of an inspection robot 100 in accordance with an example of the present disclosure. Robot 100 includes a chassis 110 on which wheels or treads may be mounted. FIGS. 1A and 1B illustrate an embodiment in which robot 100 has wheels 120L, 120R, 122L, and 122R, and FIGS. 2A and 2B, which are described further below, illustrate an embodiment in which robot 100 has treads. Robot 100 further includes a drive system containing at least one drive motor 130L or 130R, each connected to and engaged with one of a driven sprocket 114. In the example of FIGS. 1A and 1B, robot 100 has two drive motors 130L and 130R, each one having a motor shaft engaged with a driven sprocket 114, and driven wheels 120L and 120R are on or rotated by driven sprockets 114. Inspection robot 100 also has wheels 122L and 122R on sprockets 116 on axles extending from chassis 110. Sprockets 116 are not directly motor driven. Instead, drive belts 132L and 132R connected to motor driven sprockets 114 can rotate connected sprockets 116. A control system 150, which may be an on-board microprocessor system, can independently control motors 130 to rotate wheels on left or right side of inspection robot 100, which facilitates tight radius turns and precise navigation around obstacles.

Robot 100 also has a never stuck system including at least one roller 140L or 140R. The illustrated example has two rollers 140L and 140R mounted on respective axles 144L and 144R, which have ends extending from the interior or chassis 110 to an end or sprocket in outside of chassis 110. Rollers 140L and 140R project below the bottom of chassis 110 but do not extend to a plane defined by the bottoms of wheels 120R, 120L, 122R, and 122L. As shown in FIG. 1B, wheels 120R, 120L, 122R, and 122L may have traction on a flat driving surface 190, while rollers 140L and 140R are well above flat driving surface 190. Drive belts 134L and 134R engage the sprockets at the ends of axis 144L and 144R and engage respective driven sprockets 114. As a result, when a motor 130L or 130R turns the motor 130L or 130R drives not only the connected wheels 120L and 122R or 120R and 122R but also roller 140L or 140R. Accordingly, since the drive system can rotate right side wheels 120R and 122R independently of left-side wheels 120L and 122L, e.g., for steering of robot 100, the drive system can also rotate roller 140R independent of rotation of roller 140L.

As shown in FIG. 1B, chassis 110 has an underbelly or underside that may be concave to increase ground clearance near a midpoint between wheels 120 and 122. Even so, the underside of chassis 110 may contact a surface protrusion, e.g., a roof peak, which could strand a conventional robot, but rollers 140L and 140R in robot 100 extend slightly from the underside of chassis 110 and would contact a protrusion that might strand a conventional robot. FIG. 1C shows robot 100 traversing a roof 195 when the underside of chassis 110 may bottom out on a peak of roof 195. The peak may be sharp enough so that none of wheels 120R, 120L, 122R, and 122L have sufficient traction to overcome the force of the peak on the underside of chassis 110. Rollers 140L and 140R, however, may contact the peak of roof 195 and can turn robot 100 or propel robot 100 past the peak to a location or orientation where wheels 120R, 120L, 122R, and 122L gain traction. Rollers 140L and 140R being driven by motors 130L and 130R through belts 134L and 134R may thus turn robot 100 or propel robot 100 over protrusions even if robot 100 bottoms out.

FIG. 1D shows an embodiment of robot 100 in which wheels 120R, 120L, 122R, and 122L are equipped with magnetic cleats 124. Magnetic cleats 124 may be made of any magnetized material that can be attached to the perimeters of wheels 120R, 120L, 122R, and 122L. In one example, magnetic cleats 124 can have a peel-and-stick surface that allows magnetic cleats 124 to affixed to wheels 120R, 120L, 122R, and 122L for an inspection conducted on a ferromagnetic surface 185 and allow cleats 124 to be removed when not needed. Cleats (magnetic or otherwise) can improve traction on a surface, but magnetic cleats 124 can further provide magnetic attraction to ferromagnetic surface 185, e.g., a galvanized steel roof. The magnetic attraction may increase traction of robot 100 has with surface and permit robot 100 to climb or navigate on steeper surfaces.

FIGS. 2A and 2B respectively show a block diagram and a schematic side view of inspection robot 100 in a configuration in which wheels 120L, 122L, 120R, and 122R have been replaced with treads 220L and 220R. Treads 220L and 220R may be flexible belts having outer surface patterns chosen to provide traction on a particular surface or general surfaces. Additionally, peel-and-stick material such as foam or magnetized material may be applied to treads 220 L and 220R increase the traction of treads 220 and 220R on a drive surface. Treads 220L and 220R may be partially collapsible, which means that the material may collapse or compress in response to a force, and then expand when such a force is removed. For example, the left tread 220L as shown in FIG. 2A is positioned lengthwise along the left side of robot 100 and when robot 100 is placed on a diving surface 190, portions of the left tread 220L may partially collapses against surface 190 in response to the weight of inspection robot 100.

In addition to providing durability and improved traction, treads 220L, 220R cooperate with the relatively low ground clearances to keep robot 100 stable when traversing steep slopes, crossing abrupt pitch changes, or otherwise traveling on irregular terrain. Robot 100 has a quick-change system that facilitates a simple process of swapping wheels for treads. In particular, as shown in FIGS. 1A and 1B, cach drive belt 132L or 132R rides not only on sprockets 114 and 116 but also on an easily removed idler post 136L or 136R, which remove slack from drive belt 132L or 132R. Idler posts 136L and 136R also remove slack from respective roller drive belts 134L and 134R. Idler post 136L and 136R may be rollers on axles that screw into or otherwise releasably locked on chassis 110. For a swap operation, posts 136L and 136R may unscrewed or unlocked from or slide into chassis 110, which frees belts 132L, 132R, 134L, and 134R and allows the belts to be removed. Wheels 120 and 122 with sprockets 114 and 116 can be removed from axles or motor shafts. Sprockets 214 and 216 can then replace sprockets 114 and 116 on the axles or motor shafts as shown in FIGS. 2A and 2B, and treads 220L and 220R and roller drive belts 234L and 234R can be fitted on the newly installed sprockets. Posts 136L and 136R can be installed on or extended from chassis 110 to hold treads 220L and 220R and roller drive belts 234L and 234R with suitable tension on their sprockets.

The quick-change process can be similarly reversed to replace treads 220L and 220R with wheels 120L, 122L, 120R, and 122R.

An imaging system 170 of robot 100 may be a camera configured to provide still images or video, mono or stereo, transmitted in real-time and/or recorded on accessible media for later retrieval and analysis. Imaging system 170 in the illustrated example is mounted on an actuated mounting structure 180 that is extendible. Actuated mounting structure 180 may include a lower actuated hinge or swivel 182 that attaches an extendible post 184 to chassis 110 and an upper actuated hinge or swivel 186 that attaches camera 170 to the opposite end of the extendible post 184.

Imaging system 170 may include its own onboard data storage and/or it may be connected to the other onboard systems where the images or data can be stored for later use. In this aspect, the camera system makes a persistent visual record of the subject roof, crawlspace, or other area, thereby allowing people and companies to review an objective record of an inspection.

If the imaging system 170 includes a pair of cameras, the cameras may be synchronized to produce accurate stereographic images. Stereographic images may also be created virtually, by using select images from a single camera. Use of stereographic imaging apparatus may facilitate later technical analysis of the images and may allow detection of the size and shape of features, such as the roof dents caused by hail or dry rot in wood.

The imaging system 170 may also include thermal, infrared, or heat-sensing systems for detecting areas of trapped moisture, areas of heat loss (suggesting poor insulation). Detecting the heat signature from a roof, for example, can produce a map of the relative heat loss taking place in different areas of the roof.

The sensor system of robot 100 in the illustrated example may include sensors for location and navigation, and range sensors for sensing various features such as obstacles and roof edges in or on a roof, crawlspace, or other inspection area. For example, the sensors may include a digital compass or GPS system for sensing the vehicle's position, orientation, and heading relative to the earth. The sensors may further include a forward-facing sonar 152 capable of detecting obstacles in front of robot 100 and an accelerometer or tilt detecting sensor 154 that detects the orientation or tilt, e.g., pitch, roll, and yaw, of robot 100. Control system 150 can use obstacle sensor 152 and accelerometer 154 for autonomous control of the safety of robot 100. For example, the autonomous safety module may alert an operator if an obstacle is detected or stop robot 100 if the orientation of robot nears a tipping point at which robot 100 may flip over or fall into an unsafe or inoperable state.

Range sensors 156 (in addition to forward sonar 152) on inspection robot 100 may include any of a variety of suitable sensors, such as optical sensors, ultrasonic sensors, or radio-frequency sensors. For example, the vehicle may include onboard an ultrasonic range sensor such as the parallax ping ultrasonic distance detector that measures distances using sonar and interfaces with micro-controllers for communicating with other systems.

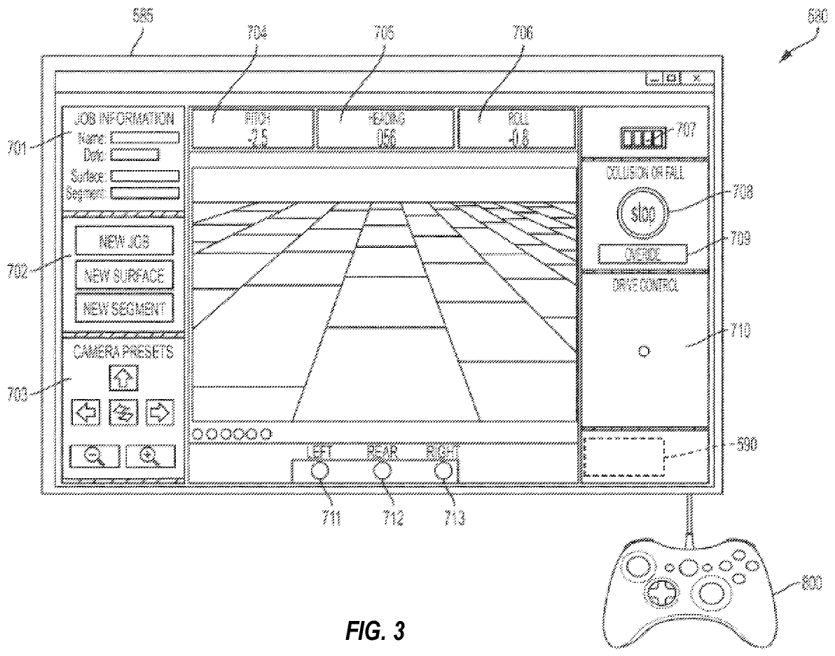

FIG. 3 illustrates a remote console 580 for use of robot 100. Remote console 580 includes a table computer 585 that provides a variety of user interface controls and a wireless transceiver 590 that is in communication with, for example, the wireless router or radio 160 onboard robot 100. Wireless transceiver 590, as the name implies, includes both a transmitter and a receiver. Remote console 580, as shown, may include a portable tablet computer 585 and a controller 800 (which includes one or more joysticks) as illustrated in FIG. 3.

Computer 585 may also include a display of the current job information 701 and an interface for entering information 702, for example, about a new job, a new surface, or a new segment under inspection. Tablet computer 585 may include a display of the images captured by the onboard imaging system 170, from any of the one or more cameras which may be present and capturing images. In this aspect, computer 585 may include a button or other selector for allowing the user to select the incoming image from one of the onboard cameras for viewing on the display. Camera buttons 703 may be used to display the incoming images from any one of the onboard cameras, any two cameras, or all the cameras, simultaneously.

Camera buttons 703 may be used to select the driving camera in image system 170 and view an overall image of the terrain. Camera buttons 703, in some examples, may be configured to select the inspection camera and to receive inputs from the user for adjusting inspection camera, for example, to pan in a certain direction, to tilt the lens, or to zoom in (or out), in order to view a desired location in greater detail.

Camera buttons 703 may be used to select a camera to see a roof shingle of interest, and to assist the user in operating a tool (not shown) mounted on robot 100. For example, robot 100 may include one or more lifter blades that robot 100 can insert beneath the edge of a roof shingle. The camera may also be selected so that the user can view the underside of a roof shingle, thus providing additional information about the status and overall condition of the shingle.

Computer 585 may also include a display of the status of one or more sensors on inspection robot 100. As illustrated in FIG. 3, across the bottom of the display, computer 585 may include a series of symbols 711, 712, 713 which, for example may be green in color (indicating a no-fault or go condition) or red (indicating a fault or stop condition). For example, the symbol 711 may display the status of the left front sensor 540L; the symbol 712 may display the status of a rear sensor on the inspection robot, and the symbol 713 may display the status of other sensors.

In another aspect, computer 585 may include a touch screen display for detecting and processing finger contacts a user applies. One or more programs stored in memory may include instructions for selecting a command based on finger contacts, processing the command, and transmitting it to the vehicle. For example, a set of available commands may include a stop command for halting the vehicle when a finger touches a stop button 708. Camera buttons 703 may generate certain commands for directing the motion of certain components of the onboard imaging system. The display may include a video feed from the onboard imaging system 170. In certain examples, the remote console includes a wireless transmitter that is dedicated to sending the video feed from the system to a second remote display such as a television or computer monitor.

A drive control command may be used to direct the motion of the vehicle in response to finger touches in the drive control area 710 of the display. As shown, a finger touch near the center of area 710 may direct the vehicle to maintain its position. Sliding the finger upward on the drive control area 710 directs the vehicle to move forward; sliding the finger to the right directs the vehicle to turn right, and so forth. The system may include a separate controller 800 such as a joystick for generating a signal that is responsive to mechanical motion by the user's fingers or hands, where the signal directs the motion of the vehicle. Use of a separate controller 800 may be preferred when the system is being used in harsh environments or conditions, such as extreme weather.

In another aspect, an override button 709 may permit the processing and transmission of drive control commands to move the vehicle even when robot 100 indicates a fault condition (from a nearby obstacle or fall risk). For example, the override button 709 may be selected when the user wishes to place the vehicle into ridge traversal mode.

According to some examples, computer 585 may be paired with and otherwise dedicated to operation with a particular vehicle. In this aspect, robot 100 and its mated computer 585 may be provided as a set to a user. The set may be purchased, leased, or otherwise provided for gathering data about a remote location such as a roof.

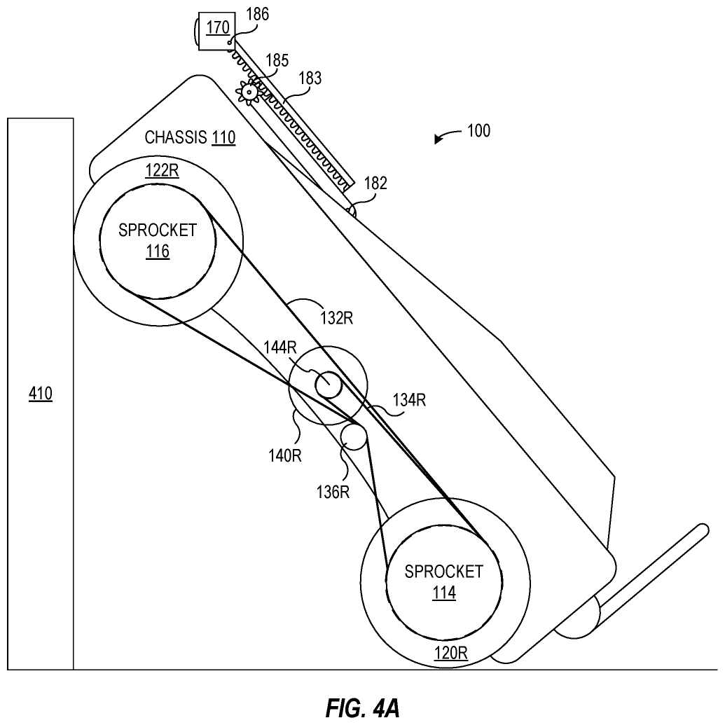

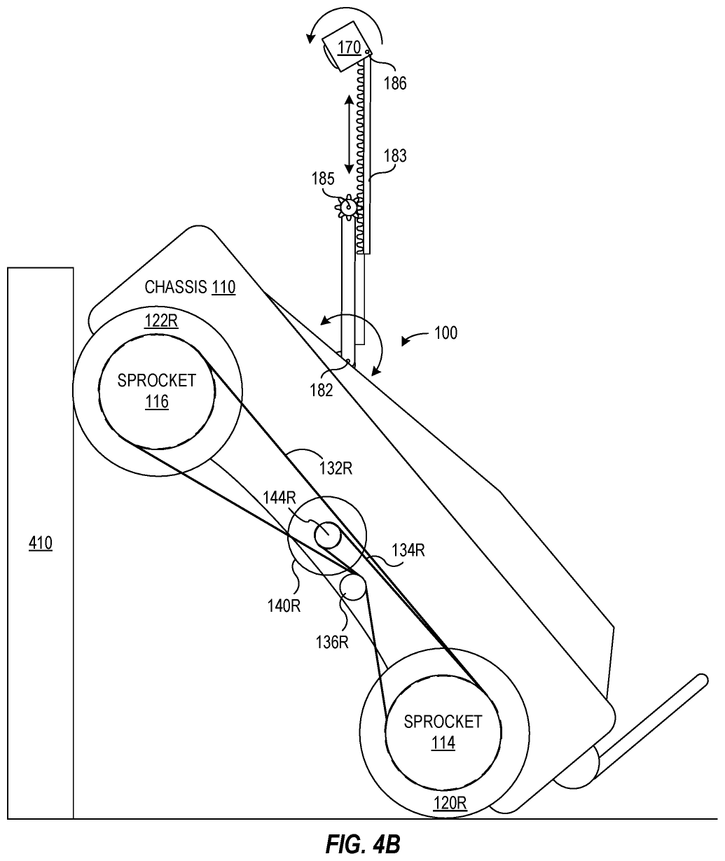

FIGS. 4A and 4B illustrate a process by which an inspection robot 100 can image or inspect a top surface of a vertical or very steep object 410. In the process of FIGS. 4A and 4B, robot 100 is driven or navigates to object 410. Robot 100 may then continue moving until the front wheels or the front portion of the treads of robot 100 have moved up the side of object 410 as shown in FIG. 4A. At or before robot 100 reaches an orientation or tilt that would risk robot 100 flipping over, controller 150 monitoring the accelerometer 154 may stop further forward movement of robot 100 and warn the remote operator of robot 100. Once in the maximum tilt position of FIG. 4A, actuated extension mounting structure 180 of robot 100 may extend to position camera 170 above the top of obstacle 410 and tilts camera 170 down to provide an image of the top of obstacle 410. Accordingly, inspection robot 100 can image surfaces or structures that robot 100 cannot climb. This capability is important, for example, for termite inspection in a crawlspace under a building where wood such as a mudsill is atop a foundation having vertical or nearly vertical sides and inspection requires viewing the wood atop the foundation to inspect for termite damage.

FIGS. 4A and 4B also illustrate an example of actuated extension mount 180 that includes a rack 183 and pinion 185 that may be motor driven to extend camera 170. Rack 183 and pinion 185 may further be attached to an actuated hinge or swivel 182 that can change the angle of rack 183 relative to the chassis 110 of robot 100. An actuate hinge or pan mounting 186 can attach camera 170 at the top of rack 183 and change the view angle of camera 170. In general, actuation of hinge 182, pinion 185, and camera pan structure 186 may be under control of the remote operator or may be an autonomous operation of robot 100.

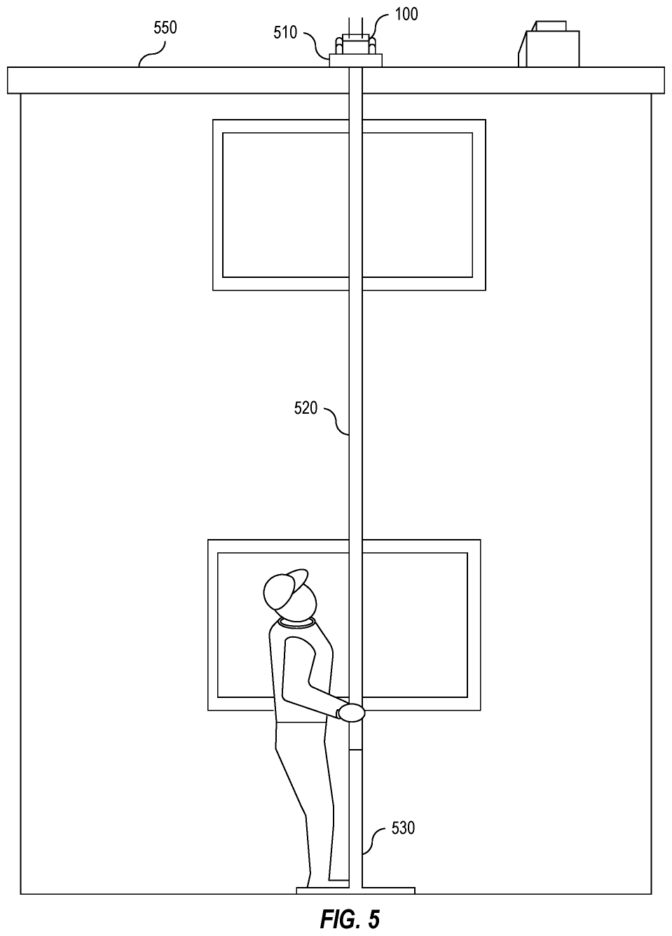

FIG. 5 illustrates a system for lifting an inspection robot 100 to an elevated surface such as a roof or for removing the inspection robot 100 from the elevated surface. The lifting system of FIG. 5 includes a basket 510, an extensible pole 520, and a base 530. For a raising or lowering process, inspection robot 100 is placed in or driven into basket 510. Basket 510 may have a flat bottom surface, walls or fencing on three sides of the bottom surface, and a partial top that extends inwardly from the walls or fencing of basket 510. The open side of basket 510 allows inspection robot 100 to drive into or out of basket 510. The partial top of basket 510 may extend over portions of a robot in basket 510, so that the robot cannot easily fall out of the top of basket 510. Basket 510 may be mounted on top of extension pole 520 using a hinge system that does not permit backet 510 to tip downward toward the open side of basket 510 but allows basket 510 to tip back toward the closed bake side of basket 510. This reduces the chance of robot 100 falling out of the open front of basket 510 but may allow robot 100 to drive forward and thereby tip the base of basket 510 to horizontal so that robot 100 can drive out of the open front of basket 510.

Extension pole 520 may be a telescoping pipe system with a bottom end that engages with and is held vertical base 530. For a raising operation, the base is positioned below an edge of an elevated surface 550, e.g., the edge of a roof. Robot 100 may be placed in basket 510 while extension pole 520 in a shortened configuration. The bottom of extension pole 520 is inserted in or attached to base 530, which holds extension pole 520 vertical. Extension pole 520 may then be extended until the bottom surface of basket 510 is at the level of or rests on elevated surface 550, at which point robot 100 may be driven out of basket 510 on to elevated surface 550. Robot 100 may then be operated to traverse and inspect elevated surface 550. When robot 100 needs to return to ground level, robot 100 may be driven back into basket 510 and extension pole 520 may be lowered.

In one specific embodiment, robot 100 has a weight of about 6 to 9 pounds with wheels 120R, 120L, 122R, and 122L or treads 220R and 220L. In this embodiment, robot 100 may be about 14 to 16 inches long and about 12 to 16 inches wide. A height of robot 100 in this embodiment may vary from about 5.5 inches to about 10.5 inches depending on whether camera 170 is extended.

Each of modules disclosed herein may include, for example, hardware devices including electronic circuitry for implementing the functionality described herein. In addition, or as an alternative, each module may be partly or fully implemented by a processor executing instructions encoded on a machine-readable storage medium.

All or portions of some of the above-described systems and methods can be implemented in a computer-readable media, e.g., a non-transient media, such as an optical or magnetic disk, a memory card, or other solid state storage containing instructions that a computing device can execute to perform specific processes that are described herein. Such media may further be or be contained in a server or other device connected to a network such as the Internet that provides for the downloading of data and executable instructions.

Although particular implementations have been disclosed, these implementations are only examples and should not be taken as limitations. Various adaptations and combinations of features of the implementations disclosed are within the scope of the following claims.

What is claimed is:

1. An inspection robot comprising:
a chassis;
wheels or treads attached to sides of the chassis and extending below the chassis;
one or more rollers in the chassis, the rollers extending from an underside of the chassis but not extending to a plane of bottoms of the wheels or treads; and
a drive system coupled to the rollers and the wheels or treads, the drive system being operable to rotate the wheels or treads and rotate the rollers.

2. The inspection robot of claim 1, further comprising:
an accelerometer or tilt sensor; and
an autonomous control system connected to the accelerometer or tilt sensor, the autonomous control system preventing movement of the inspection robot when the accelerometer or tilt sensor indicates the movement would move the inspection robot to an orientation thar risks tipping the inspection robot into an inoperable configuration.

3. The inspection robot of claim 1, further comprising:
an imaging system; and
an actuated extendible mounting system that attaches the imaging system to the chassis.

4. The inspection robot of claim 1, further comprising a quick-change system having a first configuration which mounts the wheels on the chassis and a second configuration which mounts the treads on the chassis.

5. The inspection robot of claim 1, further comprising a forward-facing sonar system that detects distances from the inspection robot to objects in front of the inspection robot.

6. The inspection robot of claim 1 further comprising magnetic cleats on the wheels or treads.

7. The inspection robot of claim 1, further comprising peel-and-stick cleats that attach to the wheels or treads.

8. The inspection robot of claim 1, wherein the one or more rollers comprises a first roller and a second roller, the drive system being configured to rotate the first roller independently of rotation of the second roller.

9. The inspection robot of claim 1, wherein the wheels or treads comprise front wheels and rear wheels, the one or more rollers being between the front wheels and the rear wheels.

10. A system for moving an inspection robot between an elevated surface and a base surface, the system comprising:
a basket sized for the inspection robot;
a telescoping pole having a top end attached to the basket; and
a base that attaches to the telescoping pole to hold the telescoping pole.
